(19) United States
(12) Patent Application Publication
(10) Pub. No.: US 2025/0319444 A1
(43) Pub. Date: Oct. 16, 2025

(54) CROSSLINKED MIXED CLAY MINERAL MEMBRANES WITH MOLECULAR FUNCTIONALIZATION

(71) Applicant: UCHICAGO ARGONNE, LLC, Chicago, IL (US)

(72) Inventors: Seth B. Darling, Berwyn, IL (US); Yining Liu, Lombard, IL (US)

(73) Assignee: UCHICAGO ARGONNE, LLC, Chicago, IL (US)

(21) Appl. No.: 18/632,128

(22) Filed: Apr. 10, 2024

(51) Int. Cl. B01D 71/02; B01D 67/00; B01D 69/12

(52) U.S. Cl. CPC B01D 71/024; B01D 67/0041; B01D 67/0076; B01D 69/1214; B01D 2323/21834; B01D 2323/30; B01D 2323/36; B01D 2323/56; B01D 2323/64; B01D 2325/42

(57) ABSTRACT

At least one aspect of the present disclosure relates to a two-dimensional mineral membrane including a first phyllosilicate material and a second phyllosilicate material crosslinked with the first phyllosilicate material, where a surface of at least one of the first phyllosilicate material or the second phyllosilicate material includes at least one functional group. Another aspect of the present disclosure relates to a method of producing a two-dimensional mineral membrane. The method includes providing a first phyllosilicate material and a second phyllosilicate material, exfoliating a mixture of the first phyllosilicate material and the second phyllosilicate material into a plurality of flakes, crosslinking the first phyllosilicate material with the second phyllosilicate material, functionalizing a surface of at least one of the first phyllosilicate material or the second phyllosilicate material, and restacking the plurality of flakes to form a membrane.

This disclosure was developed using government support under Contract No. DE-AC02-06CH11357 awarded by the United States Department of Energy to UChicago Argonne LLC, operator of Argonne National Laboratory.

### TECHNICAL FIELD

The present disclosure relates generally to membranes, and methods of producing the same. More specifically, the present disclosure relates to cross-linked, functionalized two-dimensional mineral membranes and methods of producing the same.

### BACKGROUND

Two-dimensional membranes can be implemented in a variety of use applications including, but not limited to, wastewater reuse. Water stability, ion-selectivity, and other factors can limit effectiveness and longevity of a membrane.

### SUMMARY

The foregoing summary is illustrative only and is not intended to be in any way limiting. In addition to the illustrative aspects, embodiments, and features described above, further aspects, embodiments, and features will become apparent by reference to the following drawings and the detailed description.

At least one aspect of the present disclosure relates to a two-dimensional mineral membrane. The membrane includes a first phyllosilicate material and a second phyllosilicate material crosslinked with the first phyllosilicate material, where a surface of at least one of the first phyllosilicate material or the second phyllosilicate material includes at least one functional group.

In various embodiments, at least one of the first phyllosilicate material or the second phyllosilicate material is vermiculite. In some embodiments, at least one of the first phyllosilicate material or the second phyllosilicate material is montmorillonite. In other embodiments, the first phyllosilicate material is the same as the second phyllosilicate material. In yet other embodiments, the at least one functional group includes least one of phosphonic acid or sulphonic acid. In various embodiments, the at least one functional group is selected from a group consisting of: halides, alcohols, ethers, carboxylic acids, aldehydes, acid halides, ketones, esters, amides, alkenes, and alkynes.

Another aspect of the present disclosure relates to a method of producing a two-dimensional mineral membrane. The method includes providing a first phyllosilicate material and a second phyllosilicate material. The method also includes exfoliating a mixture of the first phyllosilicate material and the second phyllosilicate material into a plurality of flakes. The method further includes crosslinking the first phyllosilicate material with the second phyllosilicate material. The method also includes functionalizing a surface of at least one of the first phyllosilicate material or the second phyllosilicate material. The method also includes restacking the plurality of flakes to form a membrane.

In various embodiments, exfoliating each of the first phyllosilicate material and the second phyllosilicate material includes refluxing the mixture of the first phyllosilicate material and the second phyllosilicate material using at least one salt solution. In some embodiments, the at least one salt solution includes a first salt solution and a second salt solution, and refluxing the mixture includes refluxing the mixture for a first period of time using the first salt solution and refluxing the mixture for a second period of time using the second salt solution. In other embodiments, the first salt solution is sodium chloride and the second salt solution is lithium chloride. In yet other embodiments, the first period of time is the same as the second period of time. In various embodiments, at least one of the first period of time or the second period of time is 24 hours. In some embodiments, exfoliating each of the first phyllosilicate material and the second phyllosilicate material further includes sonicating the mixture centrifuging the mixture to form a dispersion of the plurality of flakes.

In other embodiments, crosslinking the first phyllosilicate material with the second phyllosilicate material includes adding at least one crosslinking agent to the mixture to cause uniform crosslinking between the first phyllosilicate material and the second phyllosilicate material. In yet other embodiments, the at least one crosslinking agent is a diamine. In other embodiments, the at least one crosslinking agent is a thiol or a silatrane. In various embodiments, functionalizing the surface of at least one of the first phyllosilicate material or the second phyllosilicate material includes adding at least one functionalizing agent to the mixture and sonicating the mixture for a third period of time. In some embodiments, the at least one functionalizing agent is one of o-phosphorylethanolamine (PEA), taurine, or β-alanine. In other embodiments, restacking the plurality of flakes to form the membrane includes vacuum filtering the plurality of flakes onto a porous substrate and drying the plurality of flakes in an oven. In yet other embodiments, the method also includes comprising separating the membrane from the porous substrate.

This summary is illustrative only and should not be regarded as limiting.

### BRIEF DESCRIPTION OF THE FIGURES

A clear conception of the advantages and features constituting the present disclosure, and of the construction and operation of typical mechanisms provided with the present disclosure, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a schematic representation of a two-dimensional membrane, according to at least one embodiment.

FIG. 2 is a schematic representation of two-dimensional membrane exfoliation, according to at least one embodiment.

FIG. 3 is a flow diagram of a process of forming a cross-linked, functionalized two-dimensional membrane, according to at least one embodiment.

FIG. 4 is a perspective view of a cross-linked, functionalized two-dimensional membrane, according to at least one embodiment.

FIG. 5 is a schematic representation of a process of forming the cross-linked, functionalized two-dimensional membrane of FIG. 4, according to at least one embodiment.

FIG. 6 is a graphical representation of salt permeability versus anion size for cross-linked membranes.

FIG. 7 is a graphical representation of salt permeability versus cation size for cross-linked membranes.

FIG. 8 is a graphical representation of salt permeability for non-functionalized vermiculite membranes.

FIG. 9 is a graphical representation of salt permeability for functionalized vermiculite membranes.

FIG. 10 is a graphical representation of salt permeability for non-functionalized vermiculite membranes.

FIG. 11 is a graphical representation of salt permeability for functionalized vermiculite membranes.

FIG. 12 is a graphical representation of salt permeability versus potential hydrogen (pH) for functionalized vermiculite membranes.

FIG. 13 is a graphical representation of ion selectivity versus pH for functionalized vermiculite membranes.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

As indicated above, membrane technologies can be extensively applied to water filtration and purification applications due to their high separation efficiency, low energy input, continuous operation, and low carbon footprint. However, membrane stability, fouling, permeability-selectivity trade-off, cost, and scalability can limit use and/or longevity.

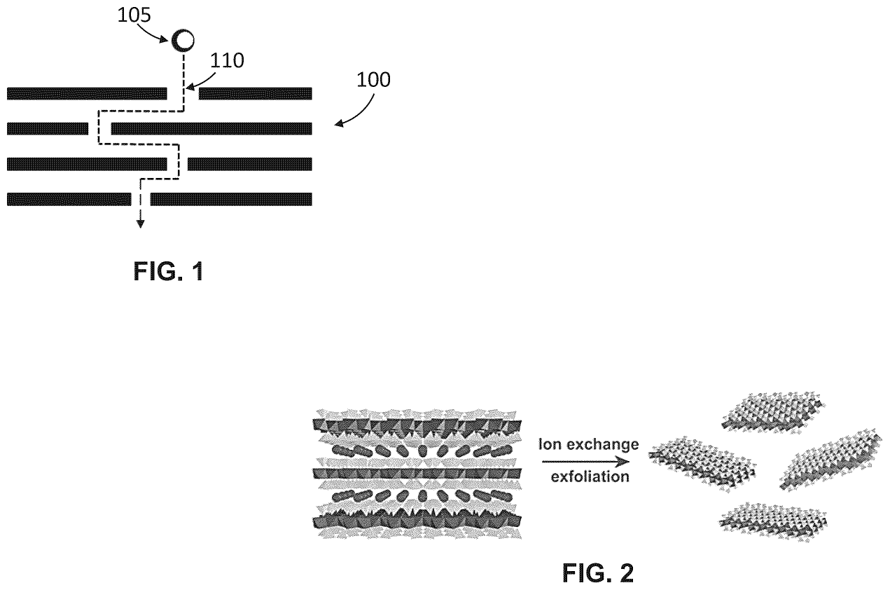

FIG. 1 is a schematic representation of a two-dimensional (2D) membrane 100. In various embodiments, 2D membranes (e.g., the 2D membrane 100) can be formed by restacking 2D material flakes into laminates. In various embodiments, the 2D material flakes can be restacked using vacuum filtration. The resulting 2D interlayer galleries provide permeation paths (e.g., permeation path 110) throughout one or more channels for the transport of ions and/or water molecules 105. In various embodiments, the size of the one or more channels and/or the chemical properties of 2D membranes can be tuned by modifying the molecular interaction and surface chemistry of the 2D materials. Adjusting the channel size and/or tuning the chemical properties of the 2D membranes can enable membrane use in one or more targeted applications. Various 2D materials have been studied for membrane applications, such as graphene oxide (GO), transitional metal dichalcogenides (TMDs), MXenes, and layered double hydroxides (LDHs). However, for these widely investigated 2D materials, there remain challenges that impact their use including, but not limited to, complex exfoliation processes, laborious surface modifications, poor water stability, and/or high material cost.

Phyllosilicate minerals are type of 2D material that have not been thoroughly studied for membrane applications. However, the phyllosilicate class of materials includes a wide variety of clays, such as smectite, vermiculite, mica, kaolinite, and serpentine. Phyllosilicate materials, which have been traditionally used in industrial applications, are typically used in bulk form as they tend to be available in abundance and cost less in comparison to other 2D materials. For example, the global production for montmorillonite (MMT), a type of smectite, was approximately 19 million tons in 2022, averaging about $97 per ton. Phyllosilicate minerals form a 2D layered structure, where each layer can include various combinations of silica tetrahedral sheets and alumina octahedral sheets. Isomorphous substitution by lower valence atoms can occur in phyllosilicates, which can lead to a permanent negative layer charge that is balanced by interlayer cations. Each phyllosilicate mineral can have its own unique combination of physical and chemical properties including, but not limited to, flake morphology, layer charge, cation species, and chemical reactivity. Accordingly, the functional versatility of phyllosilicates, combining the strengths of different phyllosilicates from the vast clay mineral library will offer great potential for targeted applications.

Prior to crosslinking or surface functionalization, phyllosilicate bulk material can be exfoliated to form 2D flakes. As shown in FIG. 2, phyllosilicates can be exfoliated through one or more liquid phase exfoliation processes to form a stable dispersion of 2D material flakes. After exfoliation, the 2D material flakes derived from the mineral material can then be restacked to form membranes via vacuum filtration. In embodiments where the 2D material includes graphene oxide, the 2D material flakes can be obtained via oxidation (e.g., Hummer's method). In such embodiments, hydrogen peroxide and/or potassium permanganate can be used as oxidants.

Research concerning phyllosilicate mineral membranes has included catalytic, electronic, and energy applications. However, as described above, little research has concerned membrane separation using phyllosilicates, which has left issues of water stability and lack of ion selectivity unsolved. Due to the weak interlamellar interactions, some phyllosilicates can gradually swell in water, leading to uncontrollable interlayer properties and structural breakdown of the membrane. Water instability can be addressed using various methods, such as surfactant intercalation or silicone rubber sealing; however, these methods can be accompanied by long-term stability issues due to unaffected interlamellar attraction.

Diamine-crosslinked phyllosilicate membranes can increase membrane water stability. Accordingly, in various embodiments, to form phyllosilicate membranes, diamine can be added to an exfoliated phyllosilicate dispersion during a crosslinking reaction and then vacuum filtered to form a 2D membrane. The crosslinking mechanism functions through electrostatic attraction between negatively charged phyllosilicate flakes and protonated diamines with positive charge. Accordingly, both amine groups of diamine molecules can crosslink phyllosilicate flakes, leading to increased binding between laminae within the membrane.

Historically, single phyllosilicate sources have been used for cross-linking. Accordingly, in various embodiments, a 2D membrane can be formed by integrating more than one mineral source material in a mixed composite. Integrating multiple mineral source materials within a single membrane can enable full utilization of the broad library of clay minerals for synergistic improvement of membrane performance. For example, vermiculite has relatively high layer charge (e.g., 0.6-0.9 per half unit cell), large aspect ratio, and a lateral size on the order of microns, which facilitates a 2D interlayer gallery with tortuous paths (e.g., as compared to paths through a comparable porous polymer membrane) and increased electrostatic interaction for ion transport (i.e., as compared to membranes having no surface charge). For example, phyllosilicate membranes are often structured such that paths through the membranes include portions that extend in both parallel and perpendicular directions relative to a plane defined by the membrane, such as shown in FIG. 1. In contrast, comparable porous polymer membranes are often structured such that paths through the membranes only include portions that extend in a direction perpendicular to a plane defined by the membrane. Accordingly, phyllosilicate (e.g., vermiculite) membranes having both perpendicular and parallel path components can be considered more tortuous as compared to paths within comparable polymer membranes. Membranes based on montmorillonite (MMT) with lower layer charge (e.g., 0.25-0.4 per half unit cell), smaller flake size (e.g., 100 nm), less tortuous paths (as compared to vermiculite), and an increased number of channels, which leads to higher water permeance and different ion interaction (e.g., due to differing layer charges between materials, crystal structure, and/or interlayer spacing, which contribute to ion transport permeability and selectivity). Accordingly, in some embodiments, a 2D membrane that includes, for example, both vermiculite and MMT can have increased water permeance as compared to vermiculite alone and increased electrostatic interaction for ion transport as compared to MMT alone.

The combination of vermiculite and MMT in the above example is an illustration of one of a variety of ways to tune membrane properties to improve membrane performance as compared to membranes formed from a single mineral source. Surface modification and/or functionalization facilitates tunabilty of a membrane's ion selectivity as compared to crosslinking methods alone since chemical properties of phyllosilicates are not engineered. Inclusion of even functional groups alone can significantly impact on the ion selectivity of 2D laminar membranes. For example, grafting a carboxylic group onto a MoS₂ membrane can increase permeability of lead ion due to the selective binding interaction thereof. Nevertheless, a universal method of surface functionalization for selective ion transport has not been explored for phyllosilicate membranes. Accordingly, it would be advantageous to combine the strengths of a diverse library of phyllosilicate minerals with ion transport selectivity to improve phyllosilicate membrane performance for use in a multitude of practical applications.

Referring generally to the figures, the present disclosure relates to crosslinking various phyllosilicates based on their unique properties to improve membrane ion selectivity through the incorporation of surface functional groups. In various embodiments, the resultant membrane is a crosslinked mixed clay mineral membrane with molecular functionalization. In various embodiments, the crosslinking process between different phyllosilicates, and/or the grafting method of different functional groups are universal and can be applied to the known phyllosilicate library.

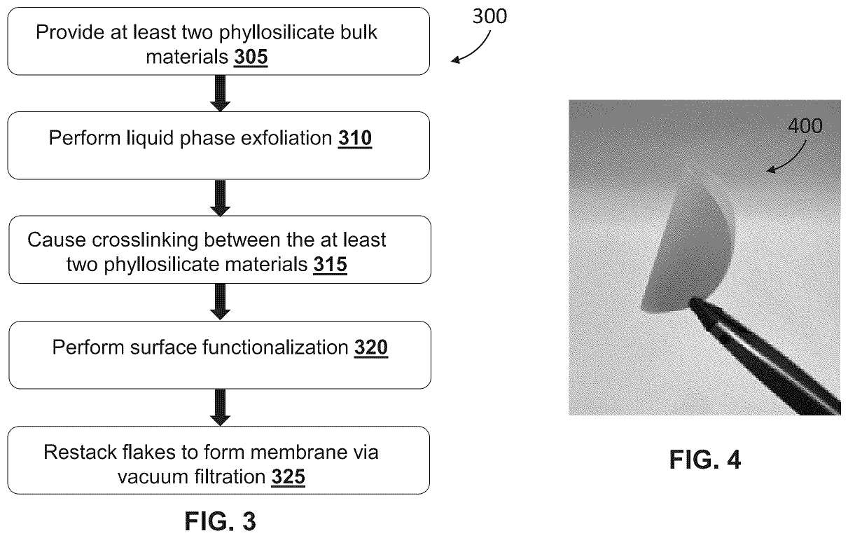

FIG. 3 is a flow diagram that illustrates a method 300 of forming a functionalized 2D membrane from crosslinked phyllosilicates. In a first step 305 of the method 300, at least two mineral materials can be obtained. In some embodiments, the mineral materials are phyllosilicate bulk materials. In other embodiments, two bulk sources of a same type of phyllosilicate can be obtained. Accordingly, in various embodiments, the method 300 can be carried out using a first phyllosilicate material and a second phyllosilicate material. In some embodiments, the first phyllosilicate material can be different than the second phyllosilicate material. In other embodiments, the first phyllosilicate material and the second phyllosilicate material can be different. In some embodiments, the first and second phyllosilicate materials can have similar physical and/or chemical properties. In yet other embodiments, the first and second phyllosilicate materials can have dissimilar physical and/or chemical properties.

In various embodiments, the first material and/or the second material (i.e., materials for 2D membranes) can be mineral materials. In some embodiments, the first material is a first phyllosilicate material and the second material is a second phyllosilicate material. In other embodiments, the first material and/or the second material can be selected from materials including a silicate tetrahedral layer and metal oxide octahedral layer.

After providing the first and second phyllosilicate materials in the step 305, liquid phase exfoliation of the first and second phyllosilicate materials can be performed in the step 310. In various implementations, each of the first and second phyllosilicate materials can be exfoliated through liquid phase exfoliation to gradually expand the respective mineral interlayers thereof to create a stable dispersion of 2D flakes. In various embodiments, exfoliation of the first and second phyllosilicate materials (“mineral material”) can include the steps of: refluxing the mineral material (i.e., in the form of a mixture of the first phyllosilicate material and the second phyllosilicate material) in at least one salt solution, sonicating the mineral material, and centrifuging the mineral material. In some implementations, the at least one salt solution includes a first salt solution and second salt solution. In some implementations, exfoliation includes refluxing the mineral material in the first salt solution and refluxing the mineral material in the second salt solution. In various embodiments, the first salt solution is a saturated sodium chloride (NaCl) solution. In some embodiments, the second salt solution is a lithium chloride solution (LiCl). In other embodiments, the first salt solution includes a first salt having a first size and the second salt solution includes a second salt with a second size, where the second size is greater than the first size. In various embodiments, using a first and second salt solution where the corresponding second salt is greater than the first salt can increase layer spacing (e.g., like a wedge) such that agitation (e.g., via ultrasonication) of the mineral material can cause complete exfoliation. In various embodiments, refluxing the mineral material in the at least one salt solution is carried out for a period of time. In some embodiments, the first period of time is at least 24 hours. In some embodiments, the mineral material is refluxed for a first period of time using the first salt solution and for a second period of time using the second salt solution. In some embodiments, the first period of time and the second period of time are the same. In other embodiments, the first period of time is greater than or less than the second period of time. In various embodiments, each of the first period of time and the second period of time is 24 hours such that the mineral material is refluxed for 48 hours total to ensure thorough replacement of interlayer cations. In other embodiments, at least one of the first period of time or the second period of time is greater than 24 hours.

The water dispersions formed from the first and second phyllosilicate material flakes generated in the step 310 can then then mixed together to form a mixture. The proportion of the first phyllosilicate material to the second phyllosilicate material in the mixture can be adjusted to tune final membrane performance. For example, the proportion of the first material to the second material can be optimized based on a target ion selectivity. In other embodiments, the proportion of the first material to the second material can be optimized based on a target water permeability. In yet other embodiments, the proportion of the first material to the second material can be optimized based on a target amount of chemical reactivity, a desired layer morphology, and/or any other desired physical or chemical characteristic. In some embodiments, more than two (e.g., 3, 5, 6, 10, 15, etc.) phyllosilicate materials can be provided in the step 305 and exfoliated in the step 310.

After exfoliation in the step 310, at least one crosslinking agent can be added to the mixture of the first and second phyllosilicate material flakes in a step 315. Addition of the crosslinking agent can cause uniform crosslinking between flakes of the first phyllosilicate material and flakes of the second phyllosilicate material. In some embodiments, the crosslinking agent is a diamine. For example, in some embodiments, the at least one crosslinking agent can include at least one of 1,2-ethanediamine, 1,4-butanediamine, or 1,6-hexanediamine. In other embodiments, molecules with functional groups that can form protonated cations in water can also be used, based on the electrostatic interaction mechanism of the crosslinking reaction. For example, in some embodiments, crosslinking agents such as dithiol, butanedithiol, ethane-1,2-dithiol (EDT), cysteamine (e.g., with amine group and thiol group on two ends), or other organic molecules can be used. In some embodiments, the at least one crosslinking agent can include a plurality of crosslinking agents. In various embodiments, the at least one crosslinking agent can be selected based on a length of the crosslinking agent molecule, which can influence an interlayer spacing of the resultant membrane. In other embodiments, multiple crosslinking agents can be used. For example, in some embodiments, the step 315 can include adding a first crosslinking agent and a second crosslinking agent. In various embodiments, the first crosslinking agent can be a diamine and the second crosslinking agent can be a dithiol or cysteamine. In some embodiments, the first and second crosslinking agents can be added to the mixture simultaneously or in series. In other embodiments, both of the first and second crosslinking agent can be diamines. In some embodiments, the at least one crosslinking agent includes a silatrane. In various embodiments, the mixture is sonicated after addition of the at least one crosslinking agent. In some implementations, the mixture is sonicated for a predetermined period of time. In some embodiments, the predetermined period of time is about 1-3 hours. In other embodiments, the predetermined period of time is greater than 3 hours, which can result in smaller flake sizes due to extended sonication.

After the crosslinking reactions in step 315, one or more functionalizing agents can be added to the mixture in a step 320 to enable grafting functional groups onto a surface of the flakes of at least one of the first and second phyllosilicate materials. In some embodiments, the mixture can be sonicated after addition of the one or more functionalizing agents. In some implementations, the mixture is sonicated for a predetermined period of time. In various embodiments, the predetermined period of time is about one hour. In yet other embodiments, the predetermined period of time is greater than one hour. In various embodiments, surface functionalization processes can be facilitated by electrostatic attraction. For example, at least one functionalizing agent molecule can contain a first functional group (e.g., an amine group) on a first end to graft onto phyllosilicate flakes, and a second functional group on a second end for selective interaction with ions transporting through the membrane. In various embodiments, various functionalizing agents can be used including, but not limited to, o-phosphorylethanolamine (PEA), taurine, and/or β-alanine. In other embodiments, the one or more functionalizing agent can include one or more functional groups from the list including, but not limited to, halides, alcohols, ethers, carboxylic acids, phosphonic acids, sulphonic acids, aldehydes, acid halides, ketones, esters, amines, amides, alkenes, alkynes, quaternary ammoniums, and fluoroalkyl chains. In various embodiments, the at least one functionalizing agent molecule, and thus the first functional group and/or second functional group, can be selected based on one or more target chemical and/or physical properties of the resultant 2D membrane. For example, in some embodiments, the at least one functionalizing agent molecule can be carboxylic acid, which can enhance filtration of lead such that the resulting 2D membrane can remove lead from water flowing through the membrane. In other embodiments, the at least one functionalizing agent molecule can include a sulphonic acid group, which can increase proton conductivity of the resultant 2D membrane in a manner similar to expensive, and more toxic commercial products (e.g., Nafion).

After surface functionalization in the step 320, the crosslinked and functionalized flakes of the first and second phyllosilicates in the dispersion can be restacked in a step 325. In various embodiments, the crosslinked and functionalized flakes of the first and second phyllosilicates in the dispersion can be vacuum filtered onto a porous substrate and dried in an oven. In some embodiments, a temperature within the oven is less than 800 degrees Celsius. In other embodiments, the temperature within the oven is approximately 200 degrees Celsius. In various embodiments, the substrate is or comprises polyvinylidene fluoride (PVDF). In other embodiments, the substrate comprises one or more other semi-crystalline thermoplastic polymers. In various embodiments, the final dried material forms a 2D crosslinked, functionalized phyllosilicate membrane. In various implementations, the resultant membrane can be used together with the substrate. In other embodiments, the resultant membrane can be separated from the substrate (e.g., via peeling) to form a free-standing membrane 400, such as shown in FIG. 4.

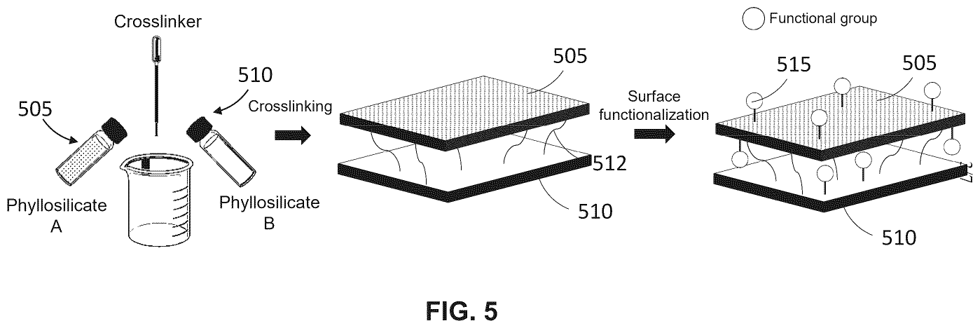

In various embodiments, the method 300 can be optimized to implement specific phyllosilicate materials, crosslinking agents, and/or functionalizing agents to form a membrane 400 having chemical and/or physical properties that are tuned for specific use applications. For example, in some embodiments, the phyllosilicate materials can be selected based on a desired characteristic of the resultant membrane. As shown in FIG. 5, a first phyllosilicate material (“phyllosilicate A”) 505 and a second phyllosilicate material (“phyllosilicate B”) 510 can be selected to form a crosslinked, functionalized phyllosilicate membrane. As described above, the first phyllosilicate material 505 and/or second phyllosilicate material 510 can be selected based on a desired permeability, ion selectivity, morphology, and/or any other characteristic. In some examples, the first phyllosilicate material 505 is vermiculite. In other examples, the second phyllosilicate material is MMT. In yet other examples, both the first phyllosilicate material 505 and the second phyllosilicate material are the same.

To enable the crosslinking step 315 of the method 300 described above, the at least one crosslinking agent should comprise a crosslinking molecule having a first end a second end, where each of the first end and the second end are positively charged. Accordingly, as shown in FIG. 5, the at least one crosslinking agent can form crosslink bonds 512 between flakes of the first phyllosilicate material 505 and flakes of the second phyllosilicate material 510. In contrast, to enable surface functionalization in the step 320 of the method 300 described above, the at least one functionalizing agent should comprise a functionalizing molecule having a first end and a second end, where one of the first end or the second end includes a charged grafting group and the other of the first end or the second end includes a functional group. Accordingly, as shown in FIG. 5, a first end of the functionalizing molecule can selectively bond to a surface of each of the first and second phyllosilicate materials 505, 510 and the functional group 515 of the functionalizing molecule can remain exposed.

Experimental results have been obtained that illustrate feasibility of methods (e.g., method 300) for forming crosslinked phyllosilicates with surface functionalization. By way of example, incorporating phosphorylethanolamine into a vermiculite membrane causes phosphonic acid groups to be grafted onto the membrane, which results in increased rejection toward phosphate salt, boosted iron (III) ion permeabilities, and enhanced sodium/potassium ion separation. Accordingly, crosslinking between different phyllosilicates and grafting surface functional groups utilize a diverse library of clay minerals to improve membrane ion transport selectivity, which enables membrane use in a variety of applications including, but not limited to, resource recovery, energy storage, and water filtration and purification.

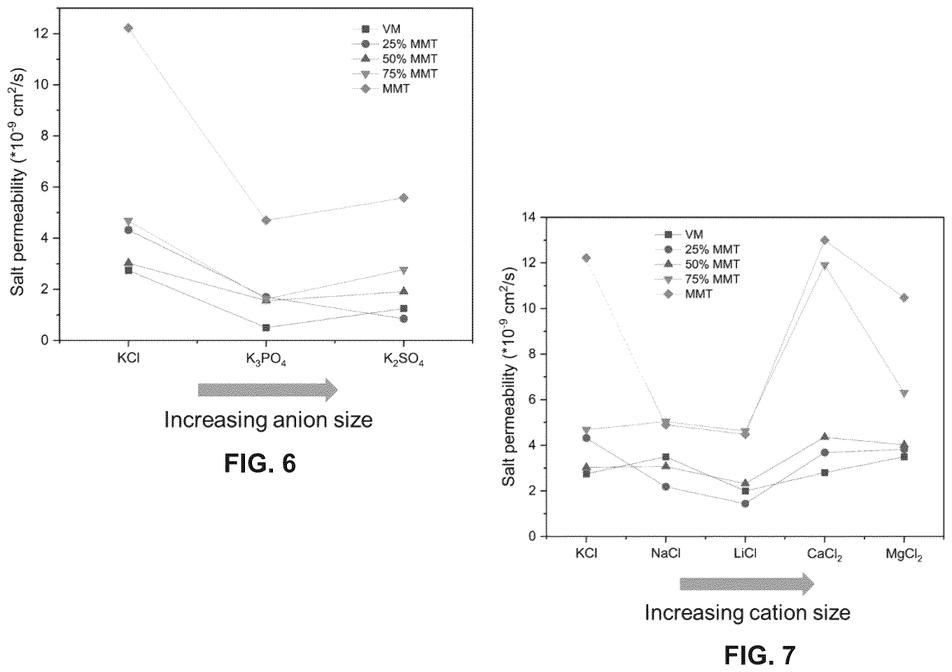

FIGS. 6 and 7 show salt permeability versus ion size for crosslinked phyllosilicate membranes formed of vermiculite alone, vermiculite with 25% MMT, vermiculite with 50% MMT, vermiculite with 75% MMT, and MMT alone. As shown in FIG. 6, salt permeability for MMT alone is greatest as compared to the other membranes tested, whereas vermiculite has the lowest salt permeability-regardless of anion size (as determined from use of potassium chloride, tribasic potassium phosphate, and potassium sulfate). As appreciated from FIG. 6, crosslinking vermiculite and MMT in varying proportions resulted in varying salt permeability. For example, as shown, membranes having 25% and 75% MMT showed greater salt permeability for lower anion sizes as compared to membranes having vermiculite alone. As appreciated from FIG. 7, salt permeability for membranes including 75% MMT increased with increasing cation size (as determined from use of potassium chloride, sodium chloride, lithium chloride, calcium chloride, and magnesium chloride), whereas membranes having less MMT displayed salt permeability behavior similar to membranes having only vermiculite. Accordingly, crosslinking multiple phyllosilicate materials can enable tuning of one or more chemical and/or physical characteristics of a resulting membrane.

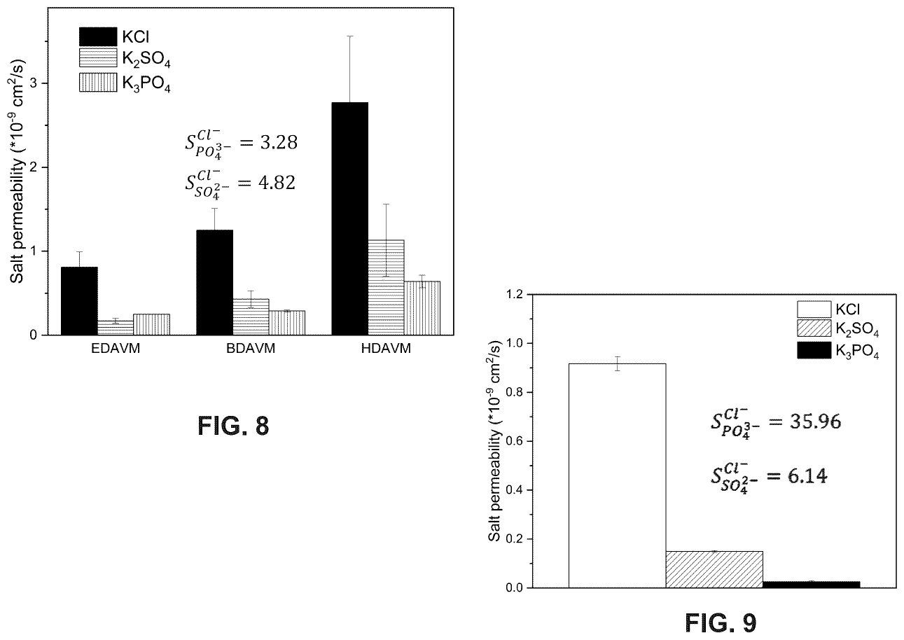

FIGS. 8 and 9 show salt permeability for crosslinked vermiculite membranes. As shown in FIG. 8, vermiculite membranes crosslinked using ethyldiamine (“EDVM”) showed comparatively lower salt permeability than vermiculite membranes crosslinked using either butanediamine (“BDAVM”) or hexanediamine (“HDAVM”). Furthermore, as shown in FIG. 8, the non-functionalized membranes displayed comparable ion selectivity for both phosphate ions and sulphate ions. By contrast, as shown in FIG. 9, membranes functionalized with o-phosphorylethanolamine (PEA) (i.e., phosphonic acid functionalized) displayed boosted rejection toward phosphates as compared to membranes without a functionalized surface. Such boosted ion selectivity resulting from surface functionalization can enable nutrient recovery in various use applications.

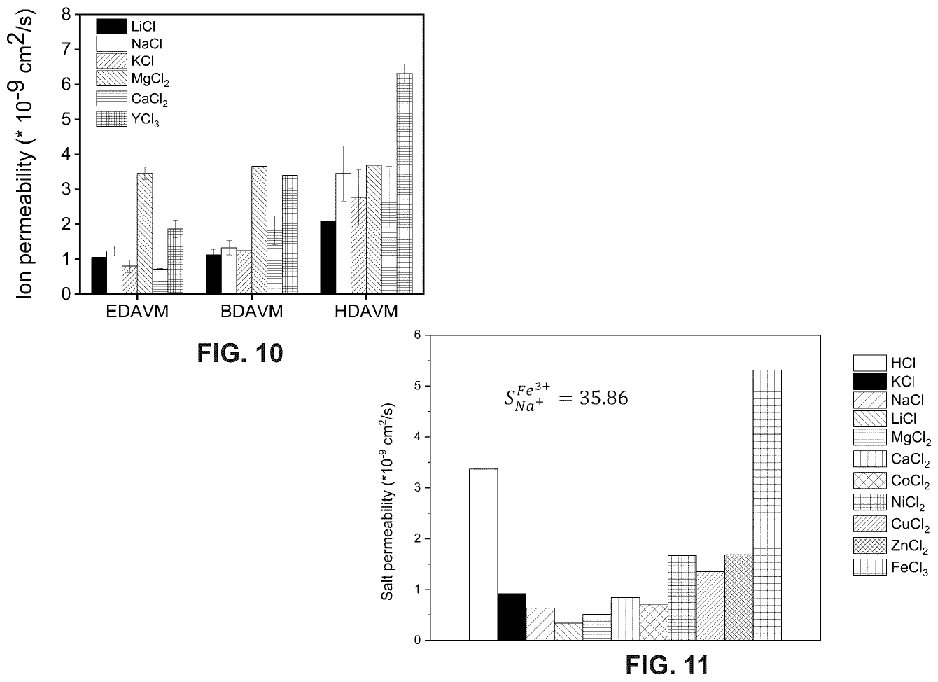

FIGS. 10 and 11 show salt permeability for crosslinked vermiculite membranes. As shown in FIG. 10, vermiculite membranes crosslinked using ethyldiamine (“EDVM”), butanediamine (“BDAVM”), or hexanediamine (“HDAVM”) showed comparatively less heavy metal ion separation than crosslinked vermiculite membranes functionalized with PEA (i.e., phosphonic acid functionalized). Such increased heavy metal ion separation resulting from surface functionalization can, for example, enable water purification in various applications.

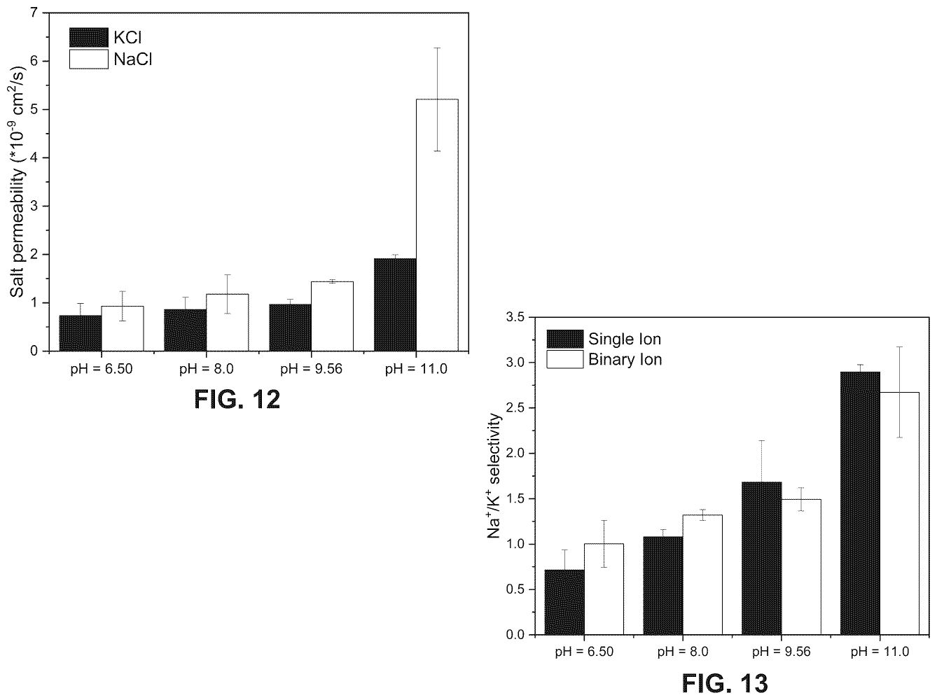

FIG. 12 shows salt permeability for crosslinked vermiculite membranes that have been functionalized using PEA (i.e., phosphonic acid functionalized). As shown in FIG. 12, potassium chloride permeability at lower pH values is comparable to sodium chloride permeability, whereas sodium chloride permeability is greater at higher pH values as compared to that of potassium chloride. This seemingly tunable potassium ion and sodium ion selectivity is further illustrated in FIG. 13. As appreciated from both FIGS. 12 and 13, functionalization of crosslinked vermiculite membranes with phosphonic acid yields a membrane having variable ion selectivity depending on pH (with a separation factor as high as 2.9). Such switchable/reversible potassium ion/sodium ion selectivity resulting from surface functionalization can, for example, enable adjustment of sodium levels in water for agricultural applications.

Although the examples described in the contexts of FIGS. 6-13 relate to specific crosslinking proportions of phyllosilicates and/or particular surface functionalization, the method 300 outlined above can be adapted to provide a crosslinked, functionalized membrane having one or more target physical and/or chemical characteristics. In various embodiments, the phyllosilicate materials (i.e., the first and second phyllosilicate materials) used to carry out the method 300 can be selected based on one or more desired physical and/or chemical characteristics (e.g., ion selectivity, salt permeability, water permeability, etc.) of the resultant membrane. In some embodiments, the at least one crosslinking agent can be selected based on one or more desired physical and/or chemical characteristics of the resultant membrane. In other embodiments, the functionalizing molecule used for surface functionalization of the phyllosilicate materials can be selected based on one or more desired physical and/or chemical characteristics of the resultant membrane.

Notwithstanding the embodiments described above in FIGS. 1-13, various modifications and inclusions to those embodiments are contemplated and considered within the scope of the present disclosure.

It is also to be understood that the construction and arrangement of the elements of the systems and methods as shown in the representative embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed.

Accordingly, all such modifications are intended to be included within the scope of the present disclosure. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other illustrative embodiments without departing from scope of the present disclosure or from the scope of the appended claims.

Furthermore, functions and procedures described above may be performed by specialized equipment designed to perform the particular functions and procedures. The functions may also be performed by general-use equipment that executes commands related to the functions and procedures, or each function and procedure may be performed by a different piece of equipment with one piece of equipment serving as control or with a separate control device.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Similarly, unless otherwise specified, the phrase “based on” should not be construed in a limiting manner and thus should be understood as “based at least in part on.” Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

Moreover, although the figures show a specific order of method operations, the order of the operations may differ from what is depicted. Also, two or more operations may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection operations, processing operations, comparison operations, and decision operations.

What is claimed is:

1. A two-dimensional mineral membrane comprising:
a first phyllosilicate material; and
a second phyllosilicate material crosslinked with the first phyllosilicate material;
wherein a surface of at least one of the first phyllosilicate material or the second phyllosilicate material comprises at least one functional group.

2. The membrane of claim 1, wherein at least one of the first phyllosilicate material or the second phyllosilicate material is vermiculite.

3. The membrane of claim 1, wherein at least one of the first phyllosilicate material or the second phyllosilicate material is montmorillonite.

4. The membrane of claim 1, wherein the first phyllosilicate material is the same as the second phyllosilicate material.

5. The membrane of claim 1, wherein the at least one functional group comprises at least one of phosphonic acid or sulphonic acid.

6. The membrane of claim 1, wherein the at least one functional group is selected from a group consisting of: halides, alcohols, ethers, carboxylic acids, aldehydes, acid halides, ketones, esters, amides, alkenes, and alkynes.

7. A method of producing a two-dimensional mineral membrane, the method comprising:
providing a first phyllosilicate material and a second phyllosilicate material;
exfoliating a mixture of the first phyllosilicate material and the second phyllosilicate material into a plurality of flakes;
crosslinking the first phyllosilicate material with the second phyllosilicate material;
functionalizing a surface of at least one of the first phyllosilicate material or the second phyllosilicate material;
restacking the plurality of flakes to form a membrane.

8. The method of claim 7, wherein exfoliating each of the first phyllosilicate material and the second phyllosilicate material comprises refluxing the mixture of the first phyllosilicate material and the second phyllosilicate material using at least one salt solution.

9. The method of claim 8, wherein the at least one salt solution comprises a first salt solution and a second salt solution; and
wherein refluxing the mixture comprises:
refluxing the mixture for a first period of time using the first salt solution; and
refluxing the mixture for a second period of time using the second salt solution.

10. The method of claim 9, wherein the first salt solution is sodium chloride and the second salt solution is lithium chloride.

11. The method of claim 9, wherein the first period of time is the same as the second period of time.

12. The method of claim 9, wherein at least one of the first period of time or the second period of time is 24 hours.

13. The method of claim 8, wherein exfoliating each of the first phyllosilicate material and the second phyllosilicate material further comprises:
sonicating the mixture; and
centrifuging the mixture to form a dispersion of the plurality of flakes.

14. The method of claim 7, wherein crosslinking the first phyllosilicate material with the second phyllosilicate material comprises adding at least one crosslinking agent to the mixture to cause uniform crosslinking between the first phyllosilicate material and the second phyllosilicate material.

15. The method of claim 14, wherein the at least one crosslinking agent is a diamine.

16. The method of claim 14, wherein the at least one crosslinking agent is a thiol or a silatrane.

17. The method of claim 7, wherein functionalizing the surface of at least one of the first phyllosilicate material or the second phyllosilicate material comprises:
adding at least one functionalizing agent to the mixture; and
sonicating the mixture for a third period of time.

18. The method of claim 17, wherein the at least one functionalizing agent is one of o-phosphorylethanolamine (PEA), taurine, or β-alanine.

19. The method of claim 7, wherein restacking the plurality of flakes to form the membrane comprises:
vacuum filtering the plurality of flakes onto a porous substrate; and
drying the plurality of flakes in an oven.

20. The method of claim 19, further comprising separating the membrane from the porous substrate.
